(19) United States
(12) Patent Application Publication
(10) Pub. No.: US 2003/0159630 A1
(43) Pub. Date: Aug. 28, 2003

(54) Pesticide application tool and method of applying pesticide below grade

(76) Inventor: Richard Randall Rollins, Atlanta, GA (US)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/084,633

(22) Filed: Feb. 27, 2002

(51) Int. Cl. A01C 23/02

(52) U.S. Cl. 111/7.4

(57) ABSTRACT

There is disclosed an improved soil treating tool for the subterranean application of pesticides. The soil treating tool comprising an elongate body portion, a handle portion attached at one end of the body portion and an applicator portion attached to the other end of the body portion. The applicator portion is sized and shaped for insertion under soil and for forming an opening in the soil by lateral movement of the handle portion. The applicator portion defines at least one fluid outlet. A fluid inlet is provided in fluid communication with the applicator portion, such that fluid applied under pressure to the inlet is dispensed from the fluid outlet. A method for the subterranean application of pesticides is also disclosed.

### FIELD OF INVENTION

The present invention relates generally to the application of pesticides to soil, and, more specifically, to the application of pesticides, such as termiticides, below grade or under the surface of the soil. The present invention also relates to a tool designed to apply liquid pesticides below grade.

### BACKGROUND OF THE INVENTION

Many types of termites are soil dwellers (i.e., subterranean termites) and exist in large colonies that can contain several million termites. Members of the colony forage for food and burrow galleries or passageways in the soil outwardly from the colony or nest, and portions of food located by foraging termites are returned to the nest. Termites can be very destructive because of their voracious appetites, especially for wood or other cellulosic materials. The ability of termites to cause considerable damage is in part due to the fact that the termites and external signs of damage is in part due to the fact that the termites are typically not seen until termite infestation is at a relatively advanced stage. Termites are difficult to detect and control because they are cryptic creatures that usually cause damage to the interiors of wooden structures, or otherwise in places that are not readily observable.

Traditional methods for controlling pests, such as termites, include preventive measures, such as pre-treatment of new construction sites with pesticidal agents to prevent subsequent infestation by pests. However, if a structure has not been pretreated or even if structures has been pre-treated, it is sometimes necessary to reapply a pesticide after a period of time or if the termites were not brought under control by the initial treatment. This is typically done by digging a shallow trench around the perimeter of a structure to be protected. Digging the trench is a labor intensive operation since it is typically done by hand with for example a hand shovel or a mattock. A liquid pesticide, such as a termiticide, is then sprayed into the open trench. After the pesticide has been applied to the trench, it must be backfilled with soil. Such a backfilling operation is also typically done by hand with a shovel or a hoe. The amount of physical labor necessary to dig and backfill a trench around the perimeter of a structure is both expensive and time consuming.

A system for the subterranean application of pesticides that avoids or reduces the digging and backfilling of a trench would be advantageous and is desirable in the art.

### SUMMARY OF THE INVENTION

The present invention satisfies the above-described needs by providing an improved pesticide application system. The improved pesticide application system comprises a tool comprising an elongate body portion, a handle portion attached at one end of the body portion and an applicator portion attached to the other end of the body portion. The applicator portion is sized and shaped for insertion under soil and for opening a furrow in the soil by lateral movement of the handle portion. The applicator portion defines at least one fluid outlet nozzle. A fluid inlet is provided in fluid communication with the applicator portion, such that fluid applied under pressure to the inlet is dispensed from the fluid outlet nozzle.

In an alternate embodiment of the present invention comprises a method for the subterranean application of pesticides. The method for the subterranean application of a pesticide comprises inserting a portion of an elongate, fluid conducting tool below the surface of soil; and laterally moving the portion of said toll not below the surface of the soil, such that the tool opens a furrow or hole or slit in the soil. Then, liquid pesticide is provided under pressure to the tool so that the liquid pesticide is conducted through the tool and dispensed from the portion of the tool below the surface of the soil into the furrow or hole or slit.

Accordingly, it is an object of the present invention to provide an improved pesticide application system.

Another object of the present invention is to provide an improved system for the subterranean application of pesticides.

A further object of the present invention is to provide a system for the application of pesticides below grade that is relatively less labor intensive compared to traditional methods of digging and backfilling a trench.

These and other objects, features and advantages of the present invention will become apparent after a review of the following detailed description of the disclosed embodiments and the appended drawing and claims.

### BRIEF DESCRIPTION OF THE DRAWING

FIG. 1 is perspective view of a disclosed embodiment of the subterranean pesticide application tool of the present invention.

FIG. 2 is a side view of the tool shown in FIG. 1.

FIG. 3 is a partial cross-sectional side view of the applicator tip of the tool shown in FIG. 1.

FIG. 4 is a perspective view of an alternate disclosed embodiment of the subterranean pesticide application tool of the present invention.

FIG. 5 is a partial cross-sectional side view of the applicator tip of the tool shown in FIG. 4.

### DETAILED DESCRIPTION OF THE DISCLOSED EMBODIMENTS

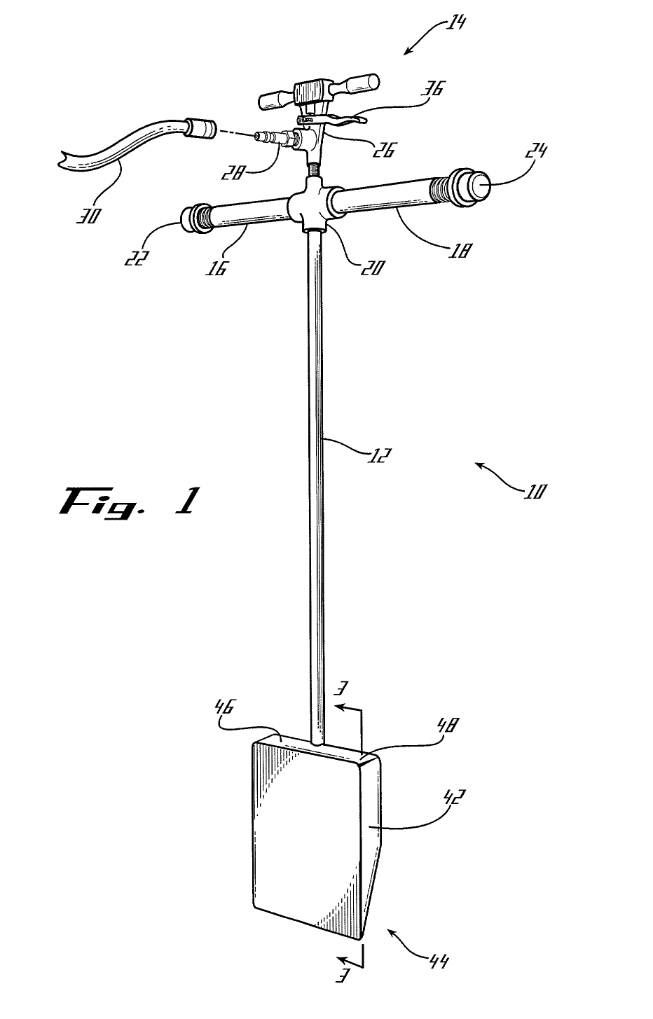

With reference to the drawing in which like numbers indicate like elements throughout the several views, it can be seen that there is a subterranean pesticide application tool 10 in accordance with the present invention. The pesticide application tool 10 is comprised of an elongate body portion 12 made from a three-foot long section of 1 inch I.D. hollow steel pipe, such as conventional gas pipe (FIG. 1). Although the present invention has been illustrated as being made from steel pipe, it is specifically contemplated that any material which has sufficient strength, can be fabricated into the desired shape and is substantially non-reactive with the pesticides with which it will be used is suitable for use in the present invention.

The body portion 12 is attached at one end to a handle portion 14. The handle portion 14 comprises a left hand grip 16 and a right hand grip 18. The left and right hand grips 16, 18 are attached to the body portion 12 by a four-way, right angle, pipe joint fitting 20. The ends of the body portion 12, left hand grip 16 and right hand grip 18 attached to the fitting 20 have male threads (not shown). Each leg of the fitting 20 has female threads (not shown) for receiving the threaded portions of the body portion 12, left hand grip 16 and right hand grip 18. Thus, the body portion 12, left hand grip 16 and right hand grip 18 are attached to the fitting 20 be screwing the ends of the body portion 12, left hand grip 16 and right hand grip 18 into the fitting 20 in a manner well known in the art. The left hand grip 16 and right hand grip 18 may be made from the same materials as the body portion 12 as described above. The left hand grip 16 and right hand grip 18 may be solid or hollow; however, if they are hollow, it is preferred that each include an end cap 22, 24. As shown in FIG. 1, the left hand grip 16 and right hand grip 18 are preferably hollow and have male threads (not shown) which mate with female threads (not shown) on the respective caps 22, 24. Thus, the caps 22, 24 are secured to and seal the ends of the left hand grip 16 and right hand grip 18, respectively, by screwing the caps onto the ends of the grips.

Attached to the remaining arm of the fitting 20 is a valve 26. The valve 26 is attached to the fitting 20 by male threads (not shown) on the valve and female threads (not shown) on the fitting. The valve 26 includes a fluid inlet 28 for connection to a hose 30 for delivering fluids under pressure to the tool 10, such as from a fluid pump 32 connected to a fluid reservoir 34. The valve 26 is manually operable by means of a lever 36. Thus, when the lever 36 is moved upwardly, as shown in FIG. 1, the valve permits fluid under pressure to flow through the valve; when the lever is released, the valve prevents fluid from flowing through the valve. Accordingly, the valve 26 permits fluid under pressure to be selectively delivered to a tube 38 attached to a fluid outlet 40 of the valve 26. The tube 38 is disposed inside the hollow body portion 12 of the tool 10.

Attached to the end of the body portion 12 remote from the valve 26 is a wedge-shaped tip that functions as a pesticide applicator tip 42. The applicator tip 42 includes a pointed end 44 for cutting sod and penetrating soil. The applicator tip 42 is sized and shaped for forming a relatively shallow and narrow in soil; i.e., approximately 6 to 12 inches below the soil's surface. The applicator tip 42 is of a width sufficient so that it provides shoulders 46, 48 on opposite sides of the body member 12 so that an operator can place his foot on one or both of the shoulders to assist in soil penetration.

The applicator tip 42 is hollow inside, thus permitting the hose 38 to extend from the body portion 12 into the applicator tip. A spray nozzle 50 is attached to a flange 52 disposed within the applicator tip 42. The spray nozzle 50 is aimed downwardly toward an elongate slot 54 or a plurality of slots or holes (not shown) defined by the applicator tip 42 adjacent the pointed end 44 thereof. The spray nozzle 50 is connected to the hose 38 so that fluid under pressure leaving the outlet 40 of the valve 26 travels through the hose to the spray nozzle. Thus, activation of the lever 36 permits fluid under pressure to be selectively sprayed from the spray nozzle 50. The recess mounting of the spray nozzle 50 in the applicator tip 42 permits applicator tip to confine the spray from the spray nozzle and direct it downwardly toward the pointed edge 44 where it exits the applicator tip 42. To facilitate this downward direction of the spray from the spray nozzle 50, it is preferred that the spray nozzle produces a fan-shaped spray pattern that is aligned with the elongate slot 54. Thus, dispensing of a fluid from the slot 54 can be selectively controlled by actuation of the lever 36.

Operation of the pesticide application tool 10 of the present invention will now be considered. The hose 30 is connected to the pump 32 which in turn is connected to the fluid reservoir 34. The fluid reservoir contains a fluid pesticide suitable for subterranean application. The particular pesticide is not critical to the present application, except that it must be a pumpable and sprayable pesticide. Thus, any sprayable liquid pesticides, including suspensions and dispersions, can be used with the present invention. Preferred pesticides that can be used with the tool 10 of the present invention include, but are not limited to, Premise, which is a combination of (S)-Methoprene and Permethrin, available from Wellmark International, Bensenville, Ill.; Fipronil Available from Aventis Environmental Science USA LP, Montvale, N.J.; Dragnet, which is Permethrin, available from FMC Corporation, Philadelphia, Pa.; and Tempo S.C., which is Cyano(4-fluro-3-phenoxyphenyl)methyl 3-(2,2-dichloroethylenyl)-2,2-dimethylcyclopropanecarboxylate, available from Bayer Corporation, Kansas City, Mo.

The pesticide application tool 10 is intended primarily to apply pesticides below grade for the treatment of subterranean termites. However, any other insects can be treated using the present invention where subterranean application of a pesticide is useful or desirable.

The pump 32 provides a source of fluid pesticide under pressure to the tool 10. The particular pressure used is not critical to the present invention and any pressure sufficient to dispense fluid pesticide out of the elongate slot 54 is useful. Generally speaking, the pressure of the fluid pesticide from the pump 32 is preferably about 15 to 30 psi.

After the hose is connected to a pressurized source of a fluid pesticide, such as the pump 32 and reservoir 34 described above, the tool 10 is used to form a furrow or hole or slit in the soil around the periphery of a structure to be protected against subterranean termites. To form the furrow in the soil, an operator (not shown) grasps the tool 10 by the handles 16, 18 and places the pointed end 44 of the applicator tip 42 on the surface of the soil (not shown). The operator then places one of his feet (not shown) on one of the shoulders 46, 48 and applies a downwardly directed pressure to the tool 10 through the shoulder and the handles 16,18, thereby causing the pointed end 44 of the tool to penetrate into the soil. The applicator tip 42 is of a sufficient size and sufficient downward pressure is applied to the tool 10 such that the pointed end 44 of the tool penetrates about 4 to 10 inches, preferably approximately 6 inches below the surface of the soil.

After the pointed end 44 of the tool 10 is inserted below the surface of the soil, as described above, the handles 16, 18 of the tool are moved laterally, back and forth to open the furrow in the soil. The body portion 12 of the tool 10 is of a sufficient length so that sufficient leverage is provided to the applicator tip 42 to relatively easily open the furrow or hole or slit in the soil. It is preferred that the body portion be approximately 5 feet long.

After the furrow or hole or slit is opened as described above, the operator squeezes the lever 36 to thereby open the valve 36. Opening of the valve causes the fluid pesticide in the reservoir 34 to flow to the pump 32, through the hose 30, in the fluid inlet 28, through the valve 26, out the fluid outlet 40, through the hose 38, spray out of the spray nozzle 50 and be dispensed out of the applicator tip 42 through the elongate slot 54 into the open furrow. Optionally, the valve 40 can include a flow meter 56 for measuring the amount of fluid pesticide dispensed from the tool 10. Alternately, the dispensing of the fluid pesticide can be timed, such as with a watch or other suitable timing device. When a desired amount of pesticide has been dispensed into the open furrow in the soil, the lever 36 is released thereby closing the valve 26 and stopping the flow of fluid pesticide out of the slot 54 into the furrow. The amount of fluid pesticide dispensed into the furrow will vary depending on the concentration of the pesticide used and the particular insect desired to be controlled.

After the desired amount of fluid pesticide has been dispensed into the open furrow, the tool 10 is withdrawn from the soil by pulling on the handles 16, 18. The process is then repeated for each approximately one foot of area to be treated until the entire periphery has been treated.

After the tool 10 is withdrawn from the soil, the furrow or hole or slit may be closed by applying pressure from the operator's foot to the soil on the sides of the furrow or hole or slit; i.e., the soil is mashed back into place. By avoiding the requirement of backfilling the trench associated with the prior art method of subterranean application of pesticides, the present invention saves a considerable amount of manual labor and time.

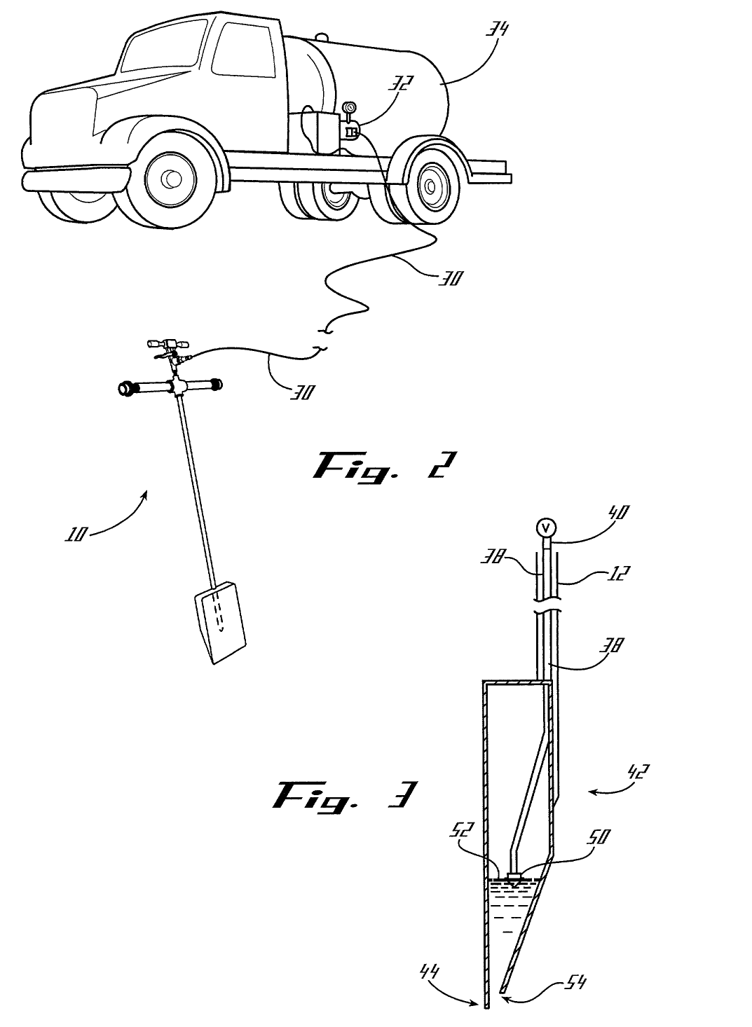

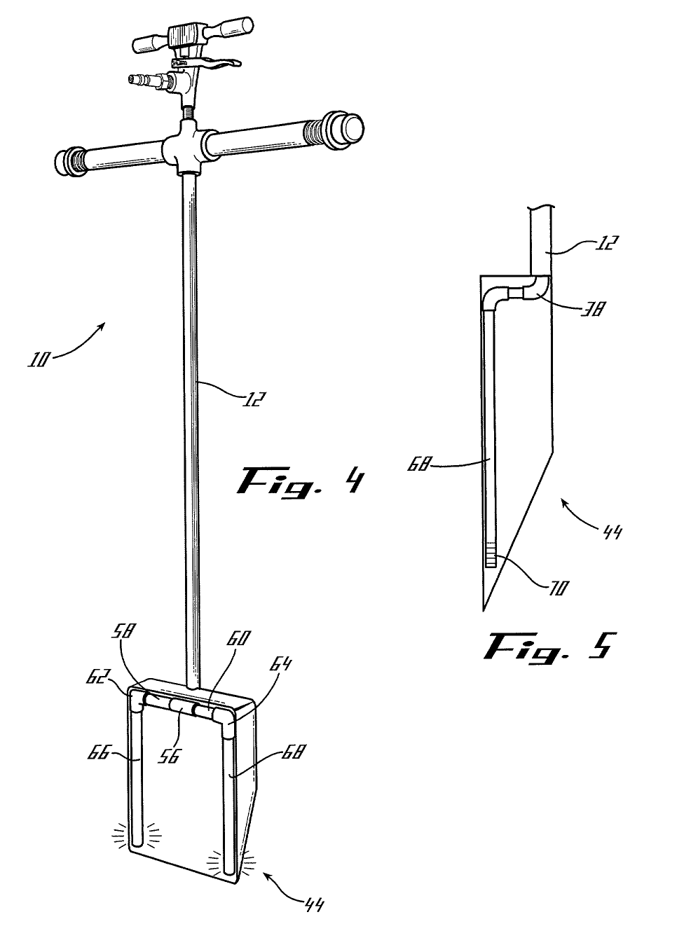

With reference to FIGS. 4 and 5, there is show an alternate embodiment of the present invention. This embodiment is identical to the embodiment illustrated in FIGS. 1-3, except for the sprayer 50, as shown above. In this alternate embodiment, the tube 38 is connected to a “T” fitting 56. The “T” fitting 56 is in turn connected to two horizontal pipes 58, 60 which have elbows 62, 64 attached at their respective ends. Prongs 66, 68 are connected to the elbows, 62, 64, respectively. The prongs 66, 68 each have slits 70 formed adjacent the ends thereof. When a fluid pesticide under pressure is delivered to the tube 38 by actuation of the valve 26, it travels through the tube 38, through the “T” fitting 56, through the pipes 58, 60, through the elbows 62, 64 and through the prongs 62, 64 when the liquid pesticide is dispensed out of the slits 70 in the prongs. The liquid pesticide will then flow out of the applicator 42 through the slots 54. This alternate embodiment is used in the same manner as described above.

It should be understood, of course, that the foregoing relates only to certain disclosed embodiments of the present invention and that numerous modifications or alterations may be made therein without departing from the spirit and scope of the invention as set forth in the appended claims.

What is claimed is:

1. A tool comprising:
an elongate body portion;
a handle portion attached at one end of the body portion;
an applicator portion attached to the other end of said body portion, said applicator portion being sized and shaped for insertion under soil and forming an opening in said soil by lateral movement of said handle portion, said applicator portion defining at least one fluid outlet;
a fluid inlet, said fluid inlet being in fluid communication with said applicator portion, such that fluid applied under pressure to said inlet is dispense from said fluid outlet.

2. The tool of claim 1 further comprising a valve interposed between said fluid inlet and said fluid outlet for selectively dispensing fluid from said fluid outlet.

3. The tool of claim 1, wherein said fluid inlet is connected to said tool adjacent said handle portion.

4. The tool of claim 1, wherein said valve is connected to said tool adjacent said handle portion.

5. The tool of claim 1, wherein said body portion is hollow so that fluid can flow therethrough.

6. The tool of claim 1, wherein said applicator tip is at least partially hollow so that fluid can flow therethrough.

7. The tool of claim 1, wherein said applicator tip is wedge-shaped.

8. The tool of claim 1, wherein said applicator tip defines a plurality of fluid nozzles disposed in a fan-shape.

9. The tool of claim 1, wherein said applicator tip defines a plurality of fluid nozzles that dispense said fluid in a stream.

10. The tool of claim 1, wherein said applicator tip houses a plurality of fluid dispensing prongs.

11. A method of applying a pesticide comprising the steps of:
inserting at least a portion of an elongate tool below the surface of soil, said tool comprising an applicator tip, a handle portion and an intermediate body portion, said applicator tip being in fluid communication with a fluid inlet port, said applicator tip defining at least one fluid outlet and a valve disposed between said inlet port and said applicator tip for selectively delivering fluid pesticide to said fluid outlet, said applicator tip being sized and shaped for below grade insertion and for opening a furrow in said soil;
moving said handle portion of said tool laterally so that said applicator tip opens a furrow in said soil; and
actuating said valve to dispense liquid pesticide from said fluid outlet into said open furrow.

12. The method of claim 11, wherein said fluid inlet is connected to said tool adjacent said handle portion.

14. The method of claim 11, wherein said body portion is hollow so that fluid can flow therethrough.

15. The method of claim 11, wherein said applicator tip is at least partially hollow so that fluid can flow therethrough.

16. The method of claim 11, wherein said applicator tip is wedge-shaped.

17. The method of claim 11, wherein said applicator tip defines an elongate slot through which fluid is dispensed.

18. A method for the subterranean application of a pesticide comprising the steps of:
inserting a portion of an elongate, fluid conducting tool below the surface of soil;
laterally moving the portion of said tool not below the surface of said soil, such that said tool opens a furrow in said soil; and
providing liquid pesticide under pressure to said tool so that said liquid pesticide is dispensed from said portion of said tool below said surface of said soil into said furrow.

19. The method of claim 18, wherein said liquid pesticide is selectively dispensed from said portion of said tool into said furrow.

20. The method of claim 19, wherein said liquid pesticide is selectively dispensed from said tool by manual operation of a valve.

21. The method of claim 20, wherein said valve is attached to said portion of said tool above said surface of said soil.

22. The method of claim 18, wherein said tool further comprises a handle portion attached to said portion of said tool above said surface of said soil.

23. A method protecting a structure against attack from subterranean termites comprising the steps of:
(a) inserting a portion of an elongate, fluid conducting tool below the surface of soil;
(b) laterally moving the portion of said tool not below the surface of said soil, such that said tool opens a furrow in said soil;
(c) providing liquid pesticide under pressure to said tool so that said liquid pesticide is dispensed from said portion of said tool below said surface of said soil into said furrow; and
(d) repeating steps a through c at intervals until a periphery of soil is treated surrounding said structure.

24. The method of claim 23, wherein said interval is approximately every foot.
